(19) United States
(12) Patent Application Publication
(10) Pub. No.: US 2011/0166680 A1
(43) Pub. Date: Jul. 7, 2011

(54) SOUND REPRODUCTION SYSTEM, CARRIER, METHOD FOR GENERATING A CORRECTION PROFILE AND SOUND REPRODUCTION METHOD

(75) Inventor: Aeldrik Pander, Den Haag (NL)

(73) Assignee: EXSILENT RESEARCH B.V., CC Amsterdam (NL)

(21) Appl. No.: 12/995,849

(22) PCT Filed: Jun. 3, 2009
(86) PCT No.: PCT/NL2009/050307

§ 371 Date: Mar. 14, 2011

(30) Foreign Application Priority Data
Jun. 3, 2008 (FR) 2001646

(51) Int. Cl. G06F 17/00

(52) U.S. Cl. 700/94

(57) ABSTRACT

A sound reproduction system includes an audio source (10) for generating an electronic audio signal which is coupled via a sound processing device (2) to reproducing elements (30) which are able and adapted to (re)produce sound in accordance with a reproduction characteristic. Programming elements (40) are able and adapted to receive an optionally frequency-dependent pre-correction, this pre-correction being able and adapted to at least partly compensate for a difference between at least one or more parts of the reproduction characteristic and a reference characteristic taken for comparison purposes, and to renew a processing characteristic on the basis of the thus obtained pre-correction. The pre-correction can be accessed separately of the reproducing elements.

The present invention relates to a sound reproduction system comprising an audio source which is coupled to a sound processing device for generating an electronic audio signal, which sound processing device is able and adapted to process an input signal into an output signal in accordance with a processing characteristic and to supply the output signal to an output, and comprising reproducing means which are coupled to the output and are able and adapted to generate sound in accordance with a reproduction characteristic on the basis of the output signal. The invention also relates to a carrier and to a method for generating a correction profile, and to a method for generating sound.

A sound reproduction system of the above stated type comprises for instance an optionally portable personal audio, video or multimedia player, wherein for instance music or video information is optionally played from a carrier received therein. The audio signal involved here is not infrequently guided via one or more sound processing devices, such as an amplifier and/or a digital signal processor (DSP), in order to impart a spatial reproduction to the sound or otherwise adapt it to the wishes of the user. The electronic audio signal is eventually reproduced acoustically by means of reproducing means in the form of for instance a loudspeaker (system) or headphones. For this purpose the reproducing means are coupled, physically or otherwise, to the output of the sound processing device.

A drawback of such a per se known sound reproduction system is that, although the sound processing device can modify the audio signal, the final sound perception will depend partly on the specific reproducing means applied. Different sorts, brands and types of reproducing means will convert the electronic audio signal to an acoustic signal, or sound, in accordance with their individual reproduction characteristic, whereby the output signal generated by the sound processing device will sound different from different reproducing means. In addition to the timbre of the sound, a particularly important factor here is the efficiency or amplification factor of the reproducing means in distinct frequency intervals. In some cases, depending on the reproducing means applied, a volume of the produced sound, despite an intended limitation thereof by the sound processing device to below a level judged to be auditively safe, can for instance hereby still exceed this level and hereby cause hearing impairment. It is otherwise noted that, where the present application refers to amplification, this must also be understood to mean damping, unless the text or context unequivocally states otherwise.

The present invention has for its object, among others, to provide a sound reproduction system in which such a dependence on reproducing means is avoided, or at least significantly reduced.

In order to achieve the stated object a sound reproduction system of the type described in the preamble has the feature according to the invention that the reproducing means are provided with individually accessible storage means on which at least a representation of the reproduction characteristic is recorded, that the sound processing device is provided with input means which are able and adapted to at least receive the at least representation of the reproduction characteristic, and that the sound processing device is provided with processing means to process the at least representation of the reproduction characteristic in combination with the processing characteristic. The reproduction characteristic for instance describes inter alia the sound and the efficiency of the reproducing means, optionally over a limited frequency range. Because this reproduction characteristic, or at least a representation thereof, is individually accessible by the input means, it can be provided independently of the reproducing means and universally applied in a sound reproduction system according to the invention.

It is noted here that it is per se known from the American patent publication U.S. Pat. No. 5,881,103 to store parameters related to reproduction characteristics of specific reproducing means in the reproducing means themselves. These data are however thus accessible only via a specific audio connection by the audio source, and thus only accessible to an audio source which is specifically modified thereto and which is compatible with such an audio connection. Because according to the invention the at least representation of the reproduction characteristic can be accessed independently of the reproducing means, such possible incompatibility problems are avoided and it is possible to opt for a specific standard therefor.

According to a preferred embodiment of the sound reproduction system according to the invention, the specific transmission characteristic of the reproducing means can already be taken into account by the sound processing device in the processing of the audio signal, and thus be anticipated by full or partial compensation being made therefor, where desired. For this purpose such a preferred embodiment according to the invention has the feature that the sound processing device can be programmed and that the processing means comprise programming means able and adapted to renew the processing characteristic on the basis of the at least representation of the reproduction characteristic.

For instance a high amplification factor or high efficiency of the reproducing means in a determined frequency range can thus be compensated in particular by the sound processing device by an opposite modification of the audio signal in the relevant frequency range. Conversely, an eventual damping can be compensated by the reproducing means in comparable manner by applying a corresponding amplification to the audio signal beforehand. A particular embodiment of the sound reproduction system according to the invention has for this purpose the feature that the at least representation of the reproduction characteristic is taken into account in an optionally frequency-dependent pre-correction, which pre-correction is intended and adapted to at least partially compensate for a difference between at least one or more parts of the reproduction characteristic and a reference characteristic taken for comparison purposes.

The result is thus an actually intended sound reproduction, corresponding to the relevant reference characteristic, in the relevant frequency interval, because account is thus taken of the reproducing means which are actually applied in the sense that compensation was made to greater or lesser extent for the specific reproduction characteristic thereof in the processing characteristic, and thus corrected. A further particular embodiment of the sound reproduction system according to the invention has the feature here that the applied reference characteristic can be selected from a group of a number of mutually differing reference characteristics. This provides the user a possibility of modifying the final reproduction to his/her personal preference within these reference characteristics.

In addition to a correction for the sound characteristic of the reproducing means, the invention also provides an option of correcting for the hearing of a listener. A particular embodiment of a sound reproduction system has for this purpose the feature according to the invention that at least a representation of a listening characteristic of the hearing of a user is also taken into account in the pre-correction in order to at least partially compensate for a difference between at least one or more parts of the listening characteristic and a reference characteristic taken for comparison purposes. In addition to the specific character of the reproducing means, the specific character of the hearing of the listener can thus also be taken into account in the processing characteristic in order for instance to correct for a determined hearing impairment or defect in the user.

Instead of being based on the overall transmission function itself for correcting, the pre-correction can also be based on a more or less complete representation thereof. Such a representation can be derived in different ways from the transmission function involved so as to be usable for the correction determining means in the sound reproduction system according to the invention. It is however important here that this takes place in a standard, predetermined manner so that the representation is eventually interpreted by the correction determining means in an intended manner and the audio signal is processed in correct manner.

For this purpose the reproduction characteristic, or the sound characteristic of the reproducing means, can for instance be compared beforehand (in the factory) to a standard reference characteristic. The same applies mutatis mutandis for the listening characteristic. From this comparison it is possible to derive processing corrections, such as in particular amplification factors, relative to the applied reference characteristic, which can be applied to the audio signal in order to modify this signal to greater or lesser extent to the chosen reference. It is noted here that, within the scope of the present patent application, unless expressly stated otherwise or otherwise apparent from the context, amplification and amplification factor is understood to mean both an amplification factor higher than or equal to one and an amplification factor lower than one, or respectively a damping or damping factor.

A particular embodiment of the sound reproduction system is characterized according to the invention in that the pre-correction comprises a frequency-dependent, at least substantially continuous correction function of a transmission function from a group comprising the reproduction characteristic, a listening characteristic of the hearing of a user and a functional product of the reproduction characteristic and the listening characteristic. The pre-correction is here a continuum over the intended frequency range enabling, if desired, the output sound of the sound reproduction system to perfectly match the sound which would have been obtained on the basis of the reference characteristic. A possibly higher or lower efficiency of the reproducing means and/or the hearing of the user relative to the applied reference can for instance thus be eliminated particularly effectively by applying a corresponding amplification or damping. Other corrections, such as for instance in the sense of timbre and spatial effect, are however also possible for the purpose of adapting the output sound to an objective reference.

A further particular embodiment of the sound reproduction system has the feature according to the invention that the correction function at least substantially comprises an inverse function of the transmission function. By thus making use within the scope of the invention of an inverse transmission function as correction for the reproducing means used and/or the hearing of the user/listener, the sound from the sound reproduction system will be perceived by the user at least substantially in fully standardized manner, irrespective of the reproducing means used and his/her hearing. This is because the influence thereof, within the limits set by the sound processing device, is almost completely eliminated. By thus determining an objective reference the behaviour and character of the specific reproducing means and/or the hearing of the user can be at least substantially fully compensated.

The most complete, and in a certain sense most perfect, correction of the audio signal is achieved per se if a correction function, for instance in one of the above described ways, or a relevant transmission function is supplied wholly or partially as a continuum so as to be incorporated in the processing characteristic. A drawback hereof is however the amount of information which is involved here and which makes for instance a manual input thereof impractical. It has however been found in practice that an effective correction is also possible with a further particular embodiment of the sound reproduction system according to the invention, which is characterized in that the pre-correction comprises a correction profile of a series of discrete correction factors at different frequency intervals for a transmission function from a group comprising the reproduction characteristic, a listening characteristic of the hearing of a user and a product of the reproduction characteristic and the listening characteristic. The pre-correction is thus presented as a (limited) correction profile of a series of discrete correction factors, in particular amplification factors, associated with individual frequency intervals. The sound processing device is programmed on the basis of this correction profile to apply, in each frequency interval, the corrections associated therewith in the profile, in particular amplification or damping corrections, on the audio signal. Particularly an output volume of the sound reproduction system can thus be adapted to the applied reference, optionally within limits chosen for this purpose, taking into account the connected reproducing means and/or the hearing of the user.

A further particular embodiment of the sound reproduction system has the feature according to the invention that, within a predetermined deviation between the transmission function and the reference characteristic, the pre-correction does not bring about any change in the processing characteristic. A correction for reproduction or listening characteristic is thus first applied if a deviation thereof exceeds a determined absolute value relative to the desired reference characteristic. Smaller deviations are however permitted in order to thus leave the specific character of the reproducing means and/or of the hearing unchanged within determined limits. The sound reproduction system hereby retains, at least to a certain extent, an individual timbre and dynamic.

The present invention can not only be applied to make the sound of the sound reproduction system at least resemble sound produced in accordance with a reference characteristic used for comparison purposes, but also provides the option of protecting the hearing of the user against a sound level which is excessively high and therefore deemed unsafe. In order to protect a user of the sound reproduction system against an excessively high, possibly harmful peak volume of the output sound, a further particular embodiment of the sound reproduction system according to the invention has the feature that the pre-correction is adapted to limit an output power of the reproducing means to a maximum level in least at one or more frequency intervals.

A further protection against an accidental overload of the hearing of the user is provided by a further preferred embodiment of the sound reproduction system according to the invention, which is characterized in that the processing means comprise recording means able and adapted to record and to totalize over time a sound load of the output signal in combination with the at least representation of the reproduction characteristic. An electronic dosimeter is thus provided in the audio source which totalizes the sound load on the hearing over time and, besides taking into account the momentary output power of the audio source, here also takes into account the transmission characteristic of the reproducing means.

When a predetermined maximum deemed as unsafe, or at least less safe, is reached, appropriate action can thus be taken by the processing means. For this purpose a further particular embodiment of the sound reproduction system according to the invention has the feature that the processing means comprise programming means for the purpose of damping the processing characteristic when a predetermined threshold value of the totalized sound load is reached. The output level of the audio source is hereby adequately limited to below a safe norm until for instance a determined, sufficient period of time has elapsed or a reset is carried out. Instead or in addition, a further particular embodiment of the sound reproduction system according to the invention has the feature that the processing means are coupled to signalling means for the purpose of generating a warning signal recognizable to the user when a predetermined threshold value of the totalized sound load is reached. The user is thus immediately aware of a potentially unsafe situation.

After being determined, the pre-correction can be presented directly to the processing means for incorporation into the processing characteristic, although it is also possible that the processing means themselves can calculate an adequate correction profile from the reproduction characteristic or a representation of one or more transmission functions for correcting, such as the reproduction characteristic and the listening profile of the user. In order to simplify the transmission of the relevant information in both cases, a further preferred embodiment of the sound reproduction system according to the invention has the feature that at least one of the reproduction characteristic, a listening characteristic of the hearing of a user and a pre-correction determined therefrom is wholly or partially encrypted into a code which is stored on a carrier and can be interpreted by the input means. The relevant information can thus be exchanged with the input means via such a carrier.

A particular embodiment of the sound reproduction system has the feature here that the carrier comprises an electronically readable memory in which the code is stored in digital form, and that the input means comprise means for electronic data exchange which are able and adapted to receive the carrier and to read the code by electronic means. By thus applying a digital code the information density of the data for transfer can be increased, and values can moreover be incorporated for the purpose of monitoring the integrity of the data. A more compact and reliable exchange with the programming means is hereby possible. Ultimately, only the digital code need be transferred, and the system is able to determine therefrom the correction(s) to be applied and take them into account in the processing characteristic.

A simpler but no less effective transfer of the relevant information is provided by a further particular embodiment of the sound reproduction system according to the invention, which is characterized in that the code can be observed visually in alphanumeric form and that the input means are able and adapted to receive the code in alphanumeric form. The relevant code can for instance thus be typed in by the user or be read optically by the input means.

In the sound reproduction system the reproducing means are coupled to the output of the processing means. In practice, this will usually be an optionally wireless physical coupling, wherein headphones, earphones, loudspeaker system or other electro-acoustic transducer is connected to the output. A preferred embodiment of the sound reproduction system here has the feature according to the invention that the digital code relating to the reproducing means is stored in the reproducing means and that the reproducing means are provided with means for electronic data exchange which are able and adapted, at least in coupled state of the reproducing means, to supply the digital code by electronic means. The digital code is here stored in electronically decipherable form in or at the reproducing means, and can be accessed by the programming means as soon as the reproducing means are connected. A modification of the sound processing device to the applied reproducing means can thus take place according to the invention without further involvement and even without the knowledge of the user, and this modification is automatically ensured when reproducing means are used which are compatible in this respect.

In a particular further embodiment the sound reproduction system according to the invention has the feature here that the programming means are provided with input means for receiving an alphanumeric representation of the digital code. If desired, such an alphanumeric code can even be entered manually by a user, provided a length of the code is used here which is acceptable to the user.

In order to offer a user a choice, if desired, in respect of the eventual timbre of the sound reproduction system, a further particular embodiment thereof has the feature according to the invention that the reference characteristic can be selected from a group comprising a number of mutually differing reference characteristics. By choosing a reference characteristic a user can thus effect a modification of the sound reproduction system of his/her choice within limits determined by the reference characteristics offered for selection.

The invention also relates to a carrier provided with a representation of at least one of the reproduction characteristic of the reproducing means, a listening characteristic of a user and a pre-correction determined therefrom for application in the sound reproduction system according to the invention. Such a carrier can for instance be an electronically readable memory in which the representation is stored or can simply be formed by a packaging or label of the reproducing means on which the representation is printed.

Serving for the first case is a further particular embodiment of the sound reproduction system according to the invention, characterized in that the representation comprises a digital code in which at least a part of the at least one of the reproduction characteristic, the listening characteristic and the pre-correction determined therefrom is encrypted.

Especially recommended in the latter case is a particular embodiment of the sound reproduction system according to the invention which is characterized in that the representation comprises an alphanumeric display of the digital code which is printed on the carrier. One or more correction profiles can for instance thus be recorded on a carrier, in particular on or at the reproducing means, to allow subsequent use thereof in the device according to the invention.

A method for generating a pre-correction profile for the reproduction characteristic of the reproducing means of the sound reproduction system according to the invention has the feature that the reproducing means are coupled to a signal generator, in particular a white noise generator, an acoustic output signal of the reproducing means is sampled in distinct frequency intervals in order to determine reproduction levels corresponding to these frequency intervals, and that in the thus obtained reproduction levels a correction factor is determined per frequency interval relative to a reference level for the relevant frequency interval taken for comparison purposes. The signal generator supplies a defined input signal wherein the same input level is for instance provided over a whole frequency range. By measuring the actual output level or output sound of the reproducing means over this frequency range it is thus relatively simple to determine a correction factor for the purpose of achieving for instance an output power that is intended to be constant over the whole frequency range. The reproduction levels thus obtained for different frequency ranges are here standardized against reference levels for the relevant frequency ranges, which serve as defined standard, and together form a correction profile which can be taken into account by the programming means as pre-correction in the processing characteristic of the sound processing means.

A method for generating a pre-correction profile for the listening characteristic of the hearing of the user of the sound reproduction system has the feature according to the invention that an acoustic signal of a varying sound level is supplied to the user in distinct frequency intervals, that a hearing threshold of the user is determined within each frequency interval, and that at the thus determined hearing threshold a correction factor is determined per frequency interval relative to a reference level for a hearing threshold in the relevant frequency interval taken for comparison purposes. It is found unnecessary in practice to correct the listening characteristic for the whole frequency spectrum. In the case that someone needs a hearing correction, this is usually the case in two to four specific frequency ranges at most. Because the ear, in contrast to different sorts, brands and types of reproducing means, has a per se known, natural transmission function in the spectrum, correction values for the user can be standardized against this more or less fixed reference curve.

A method for generating sound, wherein an electronic audio signal is obtained from an audio source and supplied to reproducing means and then converted into an acoustic output signal in accordance with a reproduction characteristic specific thereto, has the feature according to the invention that an optionally frequency-dependent pre-correction is applied to the audio signal before it is supplied to the reproducing means, which pre-correction at least partly compensates for a difference between at least one or more parts of the reproduction characteristic of the reproducing means and a reference characteristic taken for comparison purposes.

A further method for generating sound, wherein an electronic audio signal is obtained from an audio source and supplied to reproducing means and converted into an acoustic output signal, has the feature that an optionally frequency-dependent pre-correction is applied to the audio signal before it is supplied to the reproducing means, which pre-correction at least partly compensates for at least one or more parts of a listening characteristic of the hearing of a user and a reference characteristic taken for comparison purposes.

The invention will be further elucidated hereinbelow on the basis of an exemplary embodiment and an accompanying drawing. In the drawing:

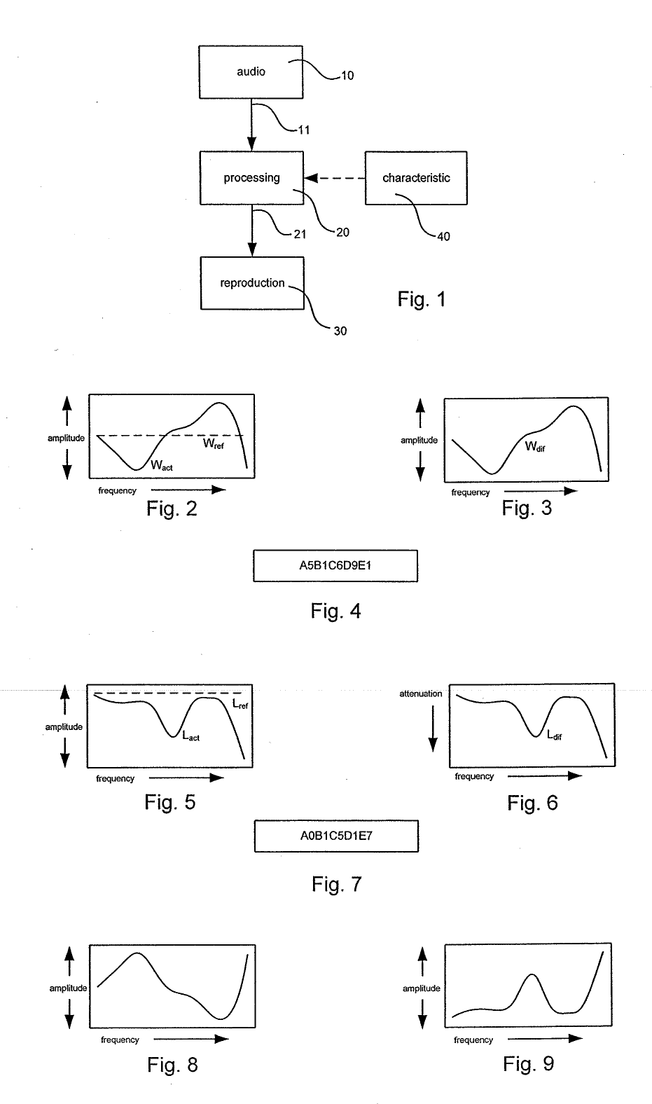

FIG. 1 shows schematically an exemplary embodiment of a sound reproduction system according to the invention;

FIG. 2 shows an example of a reproduction characteristic of reproducing means of the sound reproduction system of FIG. 1 together with a reference characteristic;

FIG. 3 shows a representation of a correction of the difference between the reproduction characteristic and reference characteristic of FIG. 2;

FIG. 4 shows an alphanumeric encoding of the representation of FIG. 3;

FIG. 5 shows an example of an audiogram of a listener together with a reference characteristic;

FIG. 6 shows a representation of a correction of the difference between the audiogram and the reference characteristic of FIG. 5;

FIG. 7 shows an alphanumeric encoding of the representation of FIG. 6;

FIG. 8 shows an example of a processing characteristic for processing means of the sound reproduction system of FIG. 1, taking into account the reproduction characteristic of FIG. 2;

FIG. 9 shows an example of a processing characteristic for processing means of the sound reproduction system of FIG. 1, taking into account the audiogram of FIG. 5; and

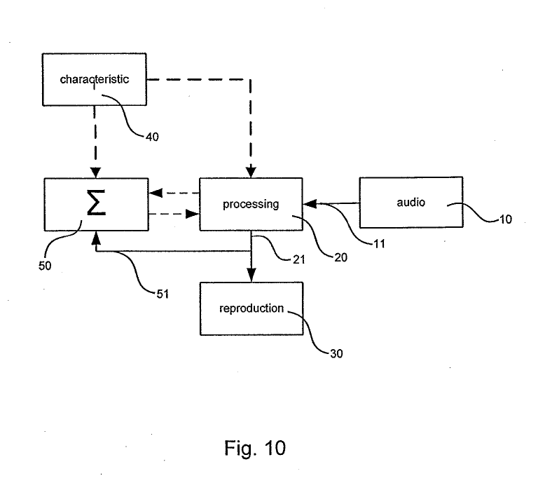

FIG. 10 shows schematically a second exemplary embodiment of a sound reproduction system according to the invention.

The figures are otherwise purely schematic and not drawn to scale. Some dimensions in particular may be exaggerated to greater or lesser extent for the sake of clarity. Corresponding parts are designated as far as possible in the figures with the same reference numeral.

The embodiment of a sound reproduction system according to the invention shown schematically in FIG. 1 comprises an audio source 10, such as for instance a hi-fi sound source, a musical instrument, a portable electronic media player, a telephone or a microphone. An electronic audio signal is taken at an output 11 of audio source 10 and presented for processing to a sound processing device 20, also referred to as digital sound processor (DSP). The audio source can here be coupled in wired as well as wireless manner to the sound processing device, and the output signal thereof can be analog as well as digital.

Sound processing device 20 is able and adapted to process the audio signal on the basis of one or more processing characteristics. In addition to optionally frequency-dependent amplification or damping of the sound, phase shifts and other effects can thus be introduced into the audio signal in order to impart a more spatial pattern or a modified timbre thereto. The thus processed audio signal is generated at an output 21 of processing device 20 and guided directly or otherwise to reproducing means 30. Reproducing means 30 convert the electronic input signal into an acoustic signal, or sound, in accordance with a transmission function specific thereto, referred to in the context of this application as reproduction characteristic, and comprise for this purpose one or more loudspeakers or other types of electro-acoustic converter. Sound processing device 20 can otherwise also serve as audio source within the scope of the invention of one or more further sound processing devices, which are then eventually coupled to such reproducing means.

The nature of the thus eventually reproduced sound has been found to depend to a significant degree on the reproducing means 30 applied. Not only an eventual timbre but also an output volume are determined to a considerable extent by the actually applied reproducing means. This follows from the reproduction characteristic of the reproducing means, which determines the conversion of the electronic input signal to the acoustic output signal in the reproducing means. FIG. 2 shows such a reproduction characteristic W_{act} by way of illustration. In addition, the sound perception by a user depends to a significant degree on his/her hearing. Great differences are sometimes also to be found here from person to person and can also be expressed in a transmission function, commonly referred to as listening characteristic or audiogram. Such an audiogram L_{act} is shown by way of illustration in FIG. 5 and provides an insight into a frequency-dependent hearing threshold of a user. The present invention provides a possibility of taking into account one or both of these factors in the processing by processing device 20 of the audio signal supplied thereto.

For this purpose processing device 20 can be programmed to enable modification of the processing characteristic applied therein. Programming means 40 are coupled, temporarily or otherwise, to the processing device with which a processing characteristic adapted to the actually applied reproducing means 30 can be loaded into processing device 20 so that the processing device then performs its function on the basis of this characteristic. Programming means 40 are here supplied with a pre-correction intended and adapted to at least partly compensate for a difference between at least one or more parts of the reproduction characteristic of the reproducing means and a reference characteristic thereof taken for comparison purposes.

The pre-correction is obtained by comparing the actual reproduction characteristic W_{act} of the reproducing means to a reference characteristic W_{ref} which is objective, uniform and therefore applied as such. A frequency-dependent correction function W_{dif} is derived from the mutual difference, as shown for instance in FIG. 3. This latter function can for instance be generated to programming means 40 so as to be incorporated into the processing characteristic of the processing means. In order to make possible the amount of information which must be exchanged for this purpose and optionally also enable a manual input, in this example the correction function W_{dif} is encrypted into a digital code from which the alphanumeric representation shown in FIG. 4 is derived. This code can be displayed on a suitable carrier on or at the reproducing means so that a user of the reproducing means can input the designated code manually into the programming means. This can otherwise be an encryption retaining at least substantially all information as well as an encryption with loss of information, wherein only uniform amplification factors for successive frequency intervals are for instance presented as a series of decimal, hexadecimal or otherwise encoded numbers or characters.

A factor can likewise be incorporated in the pre-correction to compensate for a difference between at least one or more parts of the audiogram L_{act} of the user and a reference characteristic L_{ref} thereof taken for comparison purposes, as shown by way of illustration in FIG. 6. A difference function L_{dif} can also be determined from a mutual difference therein, see FIG. 6, which function is processed into an alphanumeric representation, see FIG. 7, of a digital code with more or less retention of information.

Both pre-corrections are generated to programming means 40, either by electronic/optical means or by manual input of the intended code. On the basis hereof programming means 40 renew the original processing characteristic, see FIG. 8, of the processing means in order to thus compensate in the audio signal beforehand for the reproducing means supplied therewith afterwards and the hearing of the user. The thus determined, pre-corrected processing characteristic is shown by way of illustration in FIG. 9 and is loaded into processing device 20 by means of programming means 40. From that moment the processing device 20 is thereby adapted to the use with the actually applied reproducing means and the hearing of the user. Applied to the audio signal of audio source 10, this processing characteristic results in a full or partial compensation for the specific reproducing means, optionally in combination with the specific hearing of the user, so that the eventual sound perception will be modified at least more to an objective reference applied for this purpose. If desired, the programming means or the processing device have available a variety of references from which the user can make a choice. Because the supplied pre-correction is set off against an objective, uniform reference, it can always be reduced in reliable manner to such a selected reference.

Instead of or in addition to a pre-correction or compensation for the specifically applied reproducing means, the invention also provides a possibility of a far-reaching monitoring of an overall sound load generated over time by the reproducing means. Shown schematically in FIG. 10 is a second exemplary embodiment of a sound reproduction system according to the invention which is adapted specifically for this purpose. The characteristic 40 of the reproducing means inputted into processing means 50 makes it possible here to determine the actually reproduced sound levels. In this embodiment the processing means comprise an accumulator 50 which totalizes this output level of audio source 10 over time in a cumulative sum. By adding such an analysis function it is possible to determine the exposure to a determined amount of sound over a determined time. This analysis function can here analyse the total amount of signals, but also a part of the frequency spectrum. When a preset value or period of time is exceeded, it is possible to generate a visual or acoustic signal or allow a control function to come into operation in the processing of the signals, wherein the reproduced signal can be adjusted back fully or partially. In order to determine the amount of sound actually produced by reproducing means 30 the analysis function makes use of the reproduction characteristic 40 of the reproducing means in combination with the processing characteristic of sound processing means 20. A pre-correction or compensation of reproducing means 30 in sound processing means 20 is not absolutely necessary here, but can also be added if desired. Analysis function 50 can then also determine what the actually reproduced sound levels will be on the basis of the degree of pre-correction in combination with the reproduction characteristic.

Although the invention has been further elucidated with reference to only several embodiments, it will be apparent that the invention is by no means limited thereto. On the contrary, many other variations and embodiments are possible within the scope of the invention.

In the given example use is thus made of a static pre-correction on the basis of a predetermined, fixed correction profile. The pre-correction according to the invention can however be based on a dynamic correction profile which adapts continuously or periodically to the actual reproduction by the reproducing means, which for this purpose are electronically recorded and monitored continuously or periodically. Such an active monitoring and pre-correction can be applied with particular advantage so as to ensure that an output level of the reproducing means never exceeds a limit deemed safe.

Obtaining an audiogram is also possible in ways other than on the basis of bleeps indicated by a user as being audible or not. Defined acoustic pulses can for instance also be transmitted into the ear, and an audiogram can be derived from a reflection pattern thereof. An audiogram of the user can be calculated fully automatically on the basis of such an otoacoustic emission and reflection.

1. Sound reproduction system comprising an audio source which is coupled to a sound processing device for generating an electronic audio signal, which sound processing device is able and adapted to process an input signal into an output signal in accordance with a processing characteristic and to supply the output signal to an output, and comprising reproducing means which are coupled to the output and are able and adapted to generate sound in accordance with a reproduction characteristic on the basis of the output signal, characterized in that the reproducing means are provided with individually accessible storage means on which at least a representation of the reproduction characteristic is recorded, that the sound processing device is provided with input means which are able and adapted to at least receive the at least representation of the reproduction characteristic, and that the sound processing device is provided with processing means to process the at least representation of the reproduction characteristic in combination with the processing characteristic.

2. Sound reproduction system as claimed in claim 1, characterized in that the sound processing device can be programmed and that the processing means comprise programming means able and adapted to renew the processing characteristic on the basis of the at least representation of the reproduction characteristic.

3. Sound reproduction system as claimed in claim 2, characterized in that the at least representation of the reproduction characteristic is taken into account in an optionally frequency-dependent pre-correction, which pre-correction is intended and adapted to at least partially compensate for a difference between at least one or more parts of the reproduction characteristic and a reference characteristic taken for comparison purposes.

4. Sound reproduction system as claimed in claim 3, characterized in that the reference characteristic can be selected from a group of a number of mutually differing reference characteristics.

5. Sound reproduction system as claimed in claim 2, characterized in that at least a representation of a listening characteristic of the hearing of a user is also taken into account in the pre-correction in order to at least partially compensate for a difference between at least one or more parts of the listening characteristic and a reference characteristic taken for comparison purposes.

6. Sound reproduction system as claimed in claim 5, characterized in that the pre-correction comprises a frequency-dependent, at least substantially continuous correction function of a transmission function from a group comprising the reproduction characteristic, a listening characteristic of the hearing of a user and a functional product of the reproduction characteristic and the listening characteristic.

7. Sound reproduction system as claimed in claim 6, characterized in that the correction function at least substantially comprises an inverse function of the transmission function.

8. Sound reproduction system as claimed in claim 7, characterized in that the pre-correction comprises a correction profile of a series of discrete correction factors at different frequency intervals for a transmission function from a group comprising the reproduction characteristic, a listening characteristic of the hearing of a user and a product of the reproduction characteristic and the listening characteristic.

9. Sound reproduction system as claimed in claim 6, characterized in that within a predetermined deviation between the transmission function and the reference characteristic, the pre-correction does not bring about any change in the processing characteristic.

10. Sound reproduction system as claimed in claim 2, characterized in that the processing characteristic is renewed on the basis of the pre-correction in order to limit an output power of the reproducing means to a maximum level in least at one or more frequency intervals.

11. Sound reproduction system as claimed in claim 1, characterized in that the processing means comprise recording means able and adapted to record and to totalize over time a sound load of the output signal in combination with the at least representation of the reproduction characteristic.

12. Sound reproduction system as claimed in claim 11, characterized in that the processing means comprise programming means for the purpose of damping the processing characteristic when a predetermined threshold value of the totalized sound load is reached.

13. Sound reproduction system as claimed in claim 11, characterized in that the processing means are coupled to signalling means for the purpose of generating a warning signal recognizable to the user when a predetermined threshold value of the totalized sound load is reached.

14. Sound reproduction system as claimed in claim 1, characterized in that at least one of the reproduction characteristic, a listening characteristic of the hearing of a user and a pre-correction determined therefrom is wholly or partially encrypted into a code which is stored on a carrier and can be interpreted by the input means.

15. Sound reproduction system as claimed in claim 14, characterized in that the carrier comprises an electronically readable memory in which the code is stored in digital form, and that the input means comprise means for electronic data exchange which are able and adapted to receive the carrier and to read the code by electronic means.

16. Sound reproduction system as claimed in claim 14, characterized in that the code can be observed visually in alphanumeric form from a carrier and that the input means are able and adapted to receive the code in alphanumeric form.

17. Carrier provided with the code of the sound reproduction system as claimed in claim 14.

18. Method for generating a correction profile for the reproduction characteristic of the reproducing means of the sound reproduction system as claimed in claim 1, characterized in that the reproducing means are coupled to a signal generator, in particular a white noise generator, an acoustic output signal of the reproducing means is sampled in distinct frequency intervals in order to determine reproduction levels corresponding to these frequency intervals, and that in the thus obtained reproduction levels a correction factor is determined per frequency interval relative to a reference level for the relevant frequency interval taken for comparison purposes.

19. Method for generating a correction profile for a listening characteristic of the hearing of the user of the sound reproduction system as claimed in claim 1, characterized in that an acoustic signal of a varying sound level is supplied to the user in distinct frequency intervals, that a hearing threshold of the user is determined within each frequency interval, and that at the thus determined hearing threshold a correction factor is determined per frequency interval relative to a reference level for a hearing threshold in the relevant frequency interval taken for comparison purposes.

20. Method for generating sound, wherein an electronic audio signal is obtained from an audio source and supplied to reproducing means and then converted into sound in accordance with a reproduction characteristic specific thereto, characterized in that an optionally frequency-dependent pre-correction is applied to the audio signal before it is supplied to the reproducing means, which pre-correction at least partly compensates for a difference between at least one or more parts of the reproduction characteristic of the reproducing means and a reference characteristic taken for comparison purposes.

21. Method for generating sound, wherein an electronic audio signal is obtained from an audio source and supplied to reproducing means and converted into sound, characterized in that an optionally frequency-dependent pre-correction is applied to the audio signal before it is supplied to the reproducing means, which pre-correction at least partly compensates for at least one or more parts of a listening characteristic of the hearing of a user and a reference characteristic taken for comparison purposes.
